(19) United States
(12) Patent Application Publication
(10) Pub. No.: US 2015/0042124 A1
(43) Pub. Date: Feb. 12, 2015

(54) VEHICLE FRONT STRUCTURE

(71) Applicant: Toyota Jidosha Kabushiki Kaisha, Toyota-shi Aichi-ken (JP)

(72) Inventors: Hiroki Hyodo, Toyota-shi Aichi-ken (JP); Kenta Nomura, Nagoya-shi Aichi-ken (JP); Motoyuki Tanaka, Toyota-shi Aichi-ken (JP)

(21) Appl. No.: 14/457,598

(22) Filed: Aug. 12, 2014

(30) Foreign Application Priority Data
Aug. 12, 2013 (JP) 2013-167898

(51) Int. Cl. B60R 19/26; B60R 19/16

(52) U.S. Cl. CPC B60R 19/26; B60R 19/16
USPC 296/187.1

(57) ABSTRACT

In a vehicle front structure, a spacer protruding outwardly in a vehicle width direction from a front end of a side rail portion of a suspension member is extended toward a vehicle-width outer side relative to a front side member. Accordingly, when a vehicle has a short overlap collision with a barrier, it is possible to disperse a collision load from the barrier to the suspension member via the spacer. Besides, since the side rail portion of the suspension member is placed on the vehicle-width outer side relative to the power unit, it is possible to disperse the collision load to a power-unit side via the suspension member.

INCORPORATION BY REFERENCE

The disclosure of Japanese Patent Application No. 2013-167898 filed on Aug. 12, 2013 including the specification, drawings and abstract is incorporated herein by reference in its entirety.

### BACKGROUND OF THE INVENTION

1. Field of the Invention

The present invention relates to a vehicle front structure.

2. Description of Related Art

In a collision shock absorbing structure of a bumper reinforce of a vehicle body, described in Japanese Patent Application Publication No. 2004-189008 (JP 2004-189008 A), a bumper reinforcement is extended across front ends of right and left side members via bumper stays. Bending portions extended toward vehicle-width outer sides relative to side members are provided in both ends of the bumper reinforcement. An opening is formed on each of top and bottom faces of the bumper reinforcement so as to be placed on a straight line passing through a connecting point between the bending portion and the bumper stay. These openings decrease a rigidity of the bumper reinforcement, so that the bumper reinforcement is crushed at the time of an oblique collision, thereby preventing an unnecessary force from being added to the side member.

In the meantime, when a collision object such as an oncoming vehicle has a front end collision with an own vehicle with a small overlap amount in a vehicle width direction (at the time of a so-called short overlap collision), a collision load is mainly applied to the vehicle-width outer side relative to the side member. As a result, a lower part of a front pillar receives the collision load, thereby resulting in that a deformation amount of a passenger compartment may be increased.

### SUMMARY OF THE INVENTION

The present invention provides a vehicle front structure that is able to disperse a collision load at the time of a short overlap collision.

A vehicle front structure according to one aspect of the present invention includes: a power unit provided in a vehicle front portion; a front side member placed on a vehicle-width outer side relative to the power unit; a suspension member placed on a vehicle lower side below the front side member, and including a side rail portion placed on the vehicle-width outer side relative to the power unit; and a load transmission portion protruding from a front end of the side rail portion toward the vehicle-width outer side, the load transmission portion being extended toward the vehicle-width outer side relative to the front side member.

According to the one aspect of the present invention, the load transmission portion protruding outwardly in the vehicle width direction from the front end of the side rail portion of the suspension member is extended toward the vehicle-width outer side relative to the front side member. Accordingly, when a collision object such as an oncoming vehicle has a front end collision with an own vehicle with a small overlap amount in the vehicle width direction (at the time of a so-called short overlap collision), it is possible to disperse a collision load from the collision object to the suspension member via the load transmission portion. Besides, since the side rail portion of the suspension member is placed on the vehicle-width outer side relative to the power unit, it is possible to disperse the collision load to a power-unit side via the suspension member.

The vehicle front structure may be configured such that the load transmission portion is provided with a reinforcing portion, reinforcing portion the increasing a rigidity with respect to a load along a vehicle horizontal direction.

In the vehicle front structure, it is possible to prevent the load transmission portion from being deformed unexpectedly due to that collision load along a vehicle horizontal direction which is input into the load transmission portion from the collision object. This makes it possible to improve a transmission efficiency of the collision load via the load transmission portion.

The vehicle front structure may be configured such that: the load transmission portion includes an outer wall formed in a hollow shape; and the reinforcing portion is a reinforcing plate attached to an inner side of the outer wall.

Since the vehicle front structure is configured as such, it is possible to improve a rigidity of the load transmission portion and to achieve lightweighting.

The vehicle front structure may be configured such that at least a vehicle-width outer surface of a front side of the load transmission portion is inclined or curved outwardly in a vehicle width direction as the vehicle-width outer surface extends toward a vehicle rear side.

Since the vehicle front structure is configured as such, a collision object such as an oncoming vehicle directly or indirectly makes slide contact with the vehicle-width outer surface of the load transmission portion, thereby making it possible to successfully act a force on the vehicle front portion to move away from the collision object in a lateral direction (the vehicle width direction). As a result, it is possible to effectively reduce the collision load to be input into the vehicle front portion.

The vehicle front structure may be configured such that the load transmission portion protrudes toward a vehicle front side relative to a front end of the side rail portion.

In the vehicle front structure, it is possible to push forward a timing at which the collision load from the collision object is input into the suspension member via the load transmission portion, thereby making it possible to slow down the vehicle at an early stage by just that much. As a result, it is possible to lengthen a time for the collision load to be input into the load transmission portion.

The vehicle front structure may include: a bumper reinforcement fixed to a front end of the front side member, and including an extending portion extended toward the vehicle-width outer side relative to the front side member; and a rearward protruding portion protruding from the extending portion toward the vehicle rear side.

In the vehicle front structure, at the time of a short overlap collision, the extending portion of the bumper reinforcement is bent toward the vehicle rear side by the collision load. This allows the rearward protruding portion to abut (collide) with the vehicle-width outer surface of the front side member, thereby making it possible to bend the front side member inwardly in the vehicle width direction so as to abut with the power unit or the like. Further, at this time, it is possible to transmit the collision load from the collision object to the power unit via the load transmission portion and the side rail portion of the suspension member. Thus, it is possible to increase transmission paths of the collision load to the power unit, thereby making it possible to efficiently disperse the collision load.

The vehicle front structure may be configured such that the power unit is connected to the side rail portion.

In the vehicle front structure, it is possible to efficiently transmit, to the power unit, the collision load input into the side rail portion of the suspension member via the load transmission portion.

As described above, according to the vehicle front structure of the one aspect of the present invention, it is possible to disperse the collision load at the time of a short overlap collision.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view illustrating a vehicle front structure according to an embodiment of the present invention;

FIG. 2 is a schematic plane view illustrating the vehicle front structure;

FIG. 3 is a schematic side view illustrating the vehicle front structure;

FIG. 4 is a perspective view of a spacer provided in the vehicle front structure;

FIG. 5A is a front view illustrating the spacer;

FIG. 5B is a plan view illustrating the spacer;

FIG. 5C is a sectional view of the spacer, and illustrating a cut surface taken along a line C-C in FIG. 5B;

FIG. 5D is a side view illustrating the spacer;

FIG. 6 is a plane view corresponding to FIG. 2 to describe a state at the time of a short overlap collision; and

FIG. 7 is a side view corresponding to FIG. 3 to describe a state at the time of a short overlap collision.

### DETAILED DESCRIPTION OF EMBODIMENTS

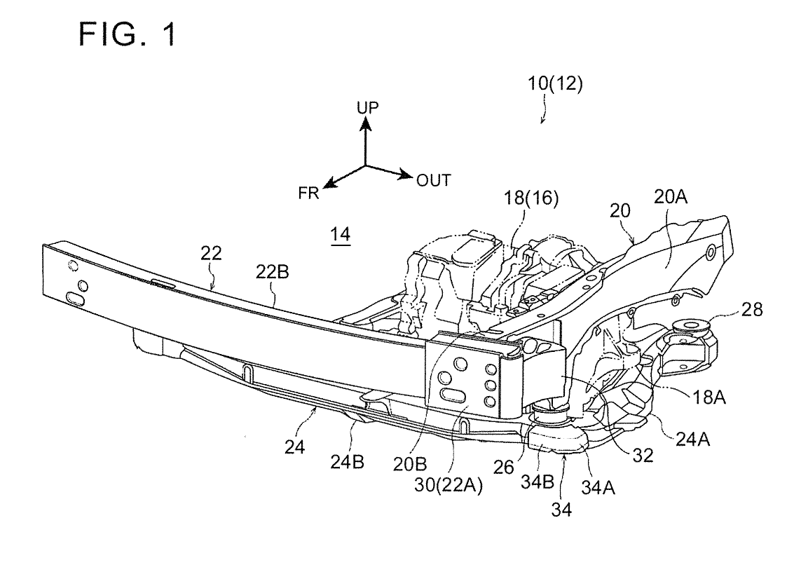

The following describes a vehicle front structure 10 according to an embodiment of the present invention with reference to FIGS. 1 to 7. Note that an arrow FR, an arrow UP, and an arrow OUT, which are shown appropriately in each figure, indicate a vehicle-body front direction (a traveling direction), a vehicle-body upper direction, and a vehicle-body outer side in a vehicle width direction, respectively. Hereinafter, in a case where a description is made by use of merely a front-rear direction, an up-down direction, and a right-left direction, they indicate front and rear of a vehicle front-rear direction, up and down of a vehicle up-down direction, and right and left of a vehicle right-left direction, respectively, unless otherwise specified.

(Configuration) FIGS. 1 to 3 illustrate the vehicle front structure 10 according to the present embodiment. A vehicle (an automobile) 12 to which the vehicle front structure 10 is applied is a sedan-type vehicle, for example. In the vehicle 12, an engine compartment 14 is formed in a vehicle front portion provided on a front side relative to a cabin (a passenger compartment) (not shown). In the engine compartment 14, a power unit 16 is accommodated. The power unit 16 includes: a drive source (not shown) including at least one of an engine and a motor; and a transmission 18. The transmission 18 is placed on one side (here, a vehicle left side) relative to the drive source in the vehicle width direction. Since the vehicle front structure 10 is configured basically in a symmetric manner, constituent components on a vehicle right side are omitted appropriately in FIGS. 1 to 3, 6, 7.

Paired right and left front side members 20 are provided at respective sides of a lower part of the engine compartment 14 in the vehicle width direction. The right and left front side members 20 are frame members for a vehicle body which frame members are formed to have a rectangular closed section when viewed from the vehicle front-rear direction, and are disposed at respective sides of the vehicle front portion with the vehicle front-rear direction being taken as a longitudinal direction.

Energy absorption portions 20B are provided in respective front parts of the right and left front side members 20. The energy absorption portions 20B are set to have a lower rigidity (offset yield strength) with respect to an axial compression load along the vehicle front-rear direction, than body portions 20A of the front side members 20. The energy absorption portions 20B are each configured such that at the time when the vehicle 12 has a front end collision (front collision), the energy absorption portion 20B absorbs an energy by being deformed before the body portion 20A is deformed. The energy absorption portion 20B may be a member (a so-called crash box) formed separately from the body portion 20A of the front side member 20.

A bumper reinforcement 22 disposed in a front end of the vehicle 12 with the vehicle width direction being taken as a longitudinal direction is fixed to front ends of the right and left energy absorption portions 20B by means of bolt fastening or the like. The bumper reinforcement 22 is a so-called B-shaped section type of which a sectional shape viewed from the vehicle width direction is formed in a generally B-like shape, and includes right and left extending portions 22A extending outwardly in the vehicle width direction beyond the right and left energy absorption portions 20B. The right and left extending portions 22A are inclined toward a vehicle rear side as they extend outwardly in the vehicle width direction. Note that an absorber (a cushioning material; not shown) made from a foam material or the like is attached to a front end face of the bumper reinforcement 22, and the absorber and the bumper reinforcement 22 are covered with a bumper cover (not shown).

Meanwhile, suspension members 24 (front suspension members) configured to support front suspensions (not shown) are disposed on respective lower sides of the right and left front side members 20. The suspension members 24 are each formed in a generally rectangular frame shape in a plane view. The suspension members 24 are placed so as to be distanced from each other in the vehicle width direction, and include paired right and left side rail portions 24A extending in the vehicle front-rear direction. Further, the suspension members 24 include: a front portion 24B configured to connect respective front ends of the right and left side rail portions 24A to each other in the vehicle width direction; and a rear portion 24C configured to connect respective rear ends of the right and left side rail portions 24A to each other in the vehicle width direction.

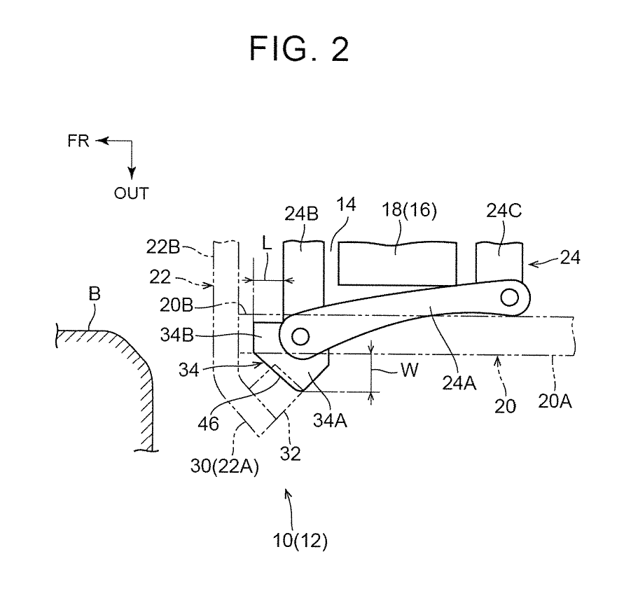

The right and left side rail portions 24A are placed, respectively, below the right and left front side members 20. A front end of each of the side rail portions 24A is connected to a front part of the body portion 20A of the front side member 20 via a front support member 26 (not shown in FIG. 2), and a rear end thereof is connected to a rear portion of the body portion 20A via a rear support member 28 (not shown except for FIG. 1).

A connection portion 18A (not shown except for FIG. 1) provided in a vehicle-width outer end (a left end) of the transmission 18 is connected to an upper part of the left side rail portion 24A via a mounting member (not shown). Hereby, the transmission 18 is supported by the suspension member 24. Note that, on a side of the power unit 16 which is opposite to the transmission 18, the drive source (not shown) is connected to (supported by) the right side rail portion 24A or the right front side member 20 via a mounting member (not shown).

The left side rail portion 24A is placed closer to a vehicle-width outer side of the transmission 18 of the power unit 16, and the left side rail portion 24A and the transmission 18 partially overlap with each other in a side view of the vehicle. Similarly, the left side rail portion 24A is placed closer to a vehicle-width outer side of the drive source of the power unit 16, and the left side rail portion 24A and the drive source partially overlap with each other in a side view of the vehicle.

(Essential part of the present embodiment) Next will be described an essential part of the present embodiment.

As illustrated in FIG. 1, in the present embodiment, the extending portion 22A of the bumper reinforcement 22 is a high-rigidity portion 30 reinforced by a reinforcement made from sheet metal or the like. Further, a rearward protruding portion 32 (a bumper-side spacer) protrudes from the high-rigidity portion 30 (the extending portion 22A) toward the vehicle rear side. The rearward protruding portion 32 is formed from metal, rein, or the like material in a generally rectangular solid shape. The rearward protruding portion 32 is fixed to a rear face of the high-rigidity portion 30 by means of welding, bolt fastening, or the like, and is opposed to a vehicle-width outer surface of the front side member 20 via a gap. The high-rigidity portion 30 and the rearward protruding portion 32 are formed so as to have a rigidity higher than the body portion 22B of the bumper reinforcement 22. Note that, in FIG. 1, the high-rigidity portion 30 on the vehicle right side is not illustrated.

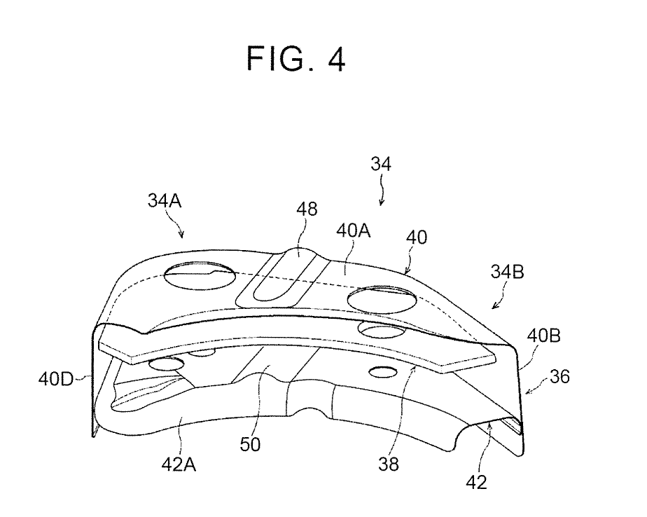

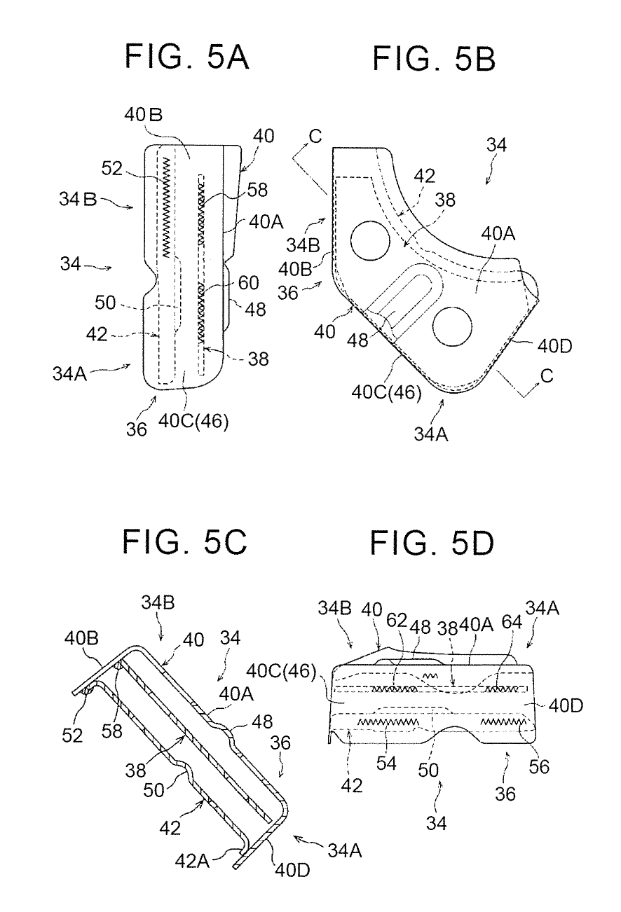

Further, in the present embodiment, a spacer 34 (a suspension-member-side spacer) serving as a load transmission portion is attached to a front end of the side rail portion 24A. As illustrated in FIG. 4 and FIGS. 5A to 5D, the spacer 34 is constituted by an outer wall 36 formed in a hollow shape, and a reinforcing plate 38 attached to an inner side of the outer wall 36. Note that, in FIGS. 2, 3, 6, 7, the high-rigidity portion 30, the rearward protruding portion 32, the spacer 34, and so on are described schematically.

The outer wall 36 is formed in combination of an upper member 40 and a lower member 42. The upper member 40 is formed by press working of a sheet metal material, and constituted by an upper wall portion 40A, and a front wall portion 40B, a side wall portion 40C, and a rear wall portion 40D extending downward from an outer circumference of the upper wall portion 40A. The upper wall portion 40A is formed in a generally J-like shape (a generally L-like shape) in a plane view, and a vehicle-width inner part thereof is cut out in an arc shape along an arc shape of the front end of the side rail portion 24A.

A thickness direction of the front wall portion 40B is along the vehicle front-rear direction, and the front wall portion 40B constitutes a front face of the spacer 34. The side wall portion 40C extends diagonally toward the vehicle rear side and the vehicle-width outer side from a vehicle-width outer end of the front wall portion 40B, and constitutes a vehicle-width outer surface of the spacer 34. Further, the rear wall portion 40D extends diagonally toward the vehicle rear side and a vehicle-width inner side from a rear end of the side wall portion 40C, and constitutes a rear face of the spacer 34. Note that the side wall portion 40C and the rear wall portion 40D are continued smoothly via an arc-shaped curved portion in a plane view.

Similarly to the upper member 40, the lower member 42 is formed by press working of a sheet metal material, so as to have a shape similar to the upper wall portion 40A of the upper member 40. A flange portion 42A extending downward is formed in an outer peripheral portion of the lower member 42, and the flange portion 42A is welded to respective bottom end sides of the front wall portion 40B, the side wall portion 40C, and the rear wall portion 40D of the upper member 40 (see welded portions 52, 54, 56 appropriately illustrated in FIGS. 5A, 5C, 5D). Hereby, the outer wall 36 having a generally box shape in which a vehicle-width inner side thereof is opened is formed.

In the meantime, the reinforcing plate 38 is formed from a sheet metal material in a flat-plate shape so as to have a shape similar to the upper wall portion 40A of the upper member 40. The reinforcing plate 38 is disposed on an inner side of the outer wall 36 so as to be parallel to the upper wall portion 40A and the lower member 42, and is placed around a center between the upper wall portion 40A and the lower member 42. The reinforcing plate 38 is welded to the front wall portion 40B, the side wall portion 40C, and the rear wall portion 40D of the upper member 40 at welded portions 58, 60, 62, 64 illustrated appropriately in FIGS. 5A, SC, 5D.

That vehicle-width inner end of the spacer 34 thus configured which is curved in an arc shape in a plane view makes contact with the front end of the side rail portion 24A, and is fixed to the front end of the side rail portion 24A by means of welding or the like. The spacer 34 is provided with: an outward protruding portion 34A protruding outwardly in the vehicle width direction from the front end of the side rail portion 24A so as to extend toward the vehicle-width outer side relative to the front side member 20; and a forward protruding portion 34B protruding toward the vehicle front side relative to the front end of the side rail portion 24A.

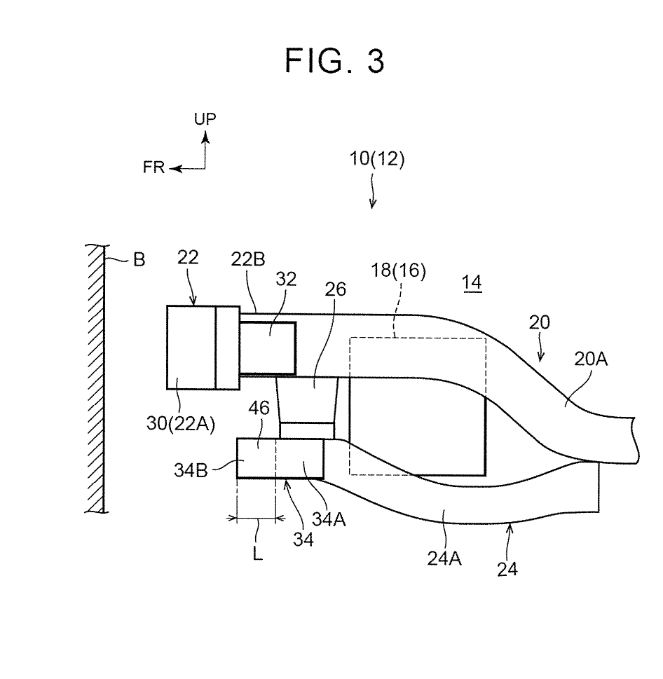

Note that a length having a reference sign W in FIG. 2 indicates a protruding amount of the outward protruding portion 34A from the vehicle-width outer surface of the front side member 20, and a length having a reference sign L in FIGS. 2 and 3 indicates a protruding amount of the forward protruding portion 34B from the front end of the side rail portion 24A. The protruding amounts are determined per vehicle, appropriately.

In the spacer 34 configured as described above, that vehicle-width outer surface of a front side thereof which is constituted by the side wall portion 40C of the upper member 40 is an inclined surface 46 inclined outwardly in the vehicle width direction as the vehicle-width outer surface extends toward the vehicle rear side. Note that the vehicle-width outer surface of the front side of the spacer 34 may be a curved surface curved outwardly in the vehicle width direction as the vehicle-width outer surface extends toward the vehicle rear side. Further, the inclined surface 46 or the curved surface may be provided over a rear side of the spacer 34.

The spacer 34 is configured such that the upper wall portion 40A of the upper member 40, the reinforcing plate 38, and the lower member 42 are all placed along a vehicle horizontal direction. The reinforcing plate 38 is attached to the inner side of the outer wall 36, thereby increasing a rigidity of the spacer 34 with respect to a load in the vehicle horizontal direction. Further, the upper wall portion 40A and the lower member 42 are respectively provided with bead portions 48, 50 each projecting upward. The bead portions 48, 50 are set so as to extend diagonally from a vicinal area of the inclined surface 46 of the spacer 34 toward the vehicle rear side and the vehicle-width inner side and to reach a vicinal area of the front end of the side rail portion 24A. This increases the rigidity of the spacer 34 with respect to a load input into the inclined surface 46 from the vehicle front side. The rigidity of the spacer 34 is set higher than at least the energy absorption portion 20B of the front side member 20.

Note that a fixation method of the spacer 34 to the side rail portion 24A is not limited to welding, and various methods such as bolt fastening, rivet fastening, and adhesion can be used. Further, a material of the spacer 34 is not limited to sheet metal, and can be changed appropriately. For example, the spacer 34 may be formed from a resin material, provided that a desired rigidity can be secured with respect to the after-mentioned collision load F.

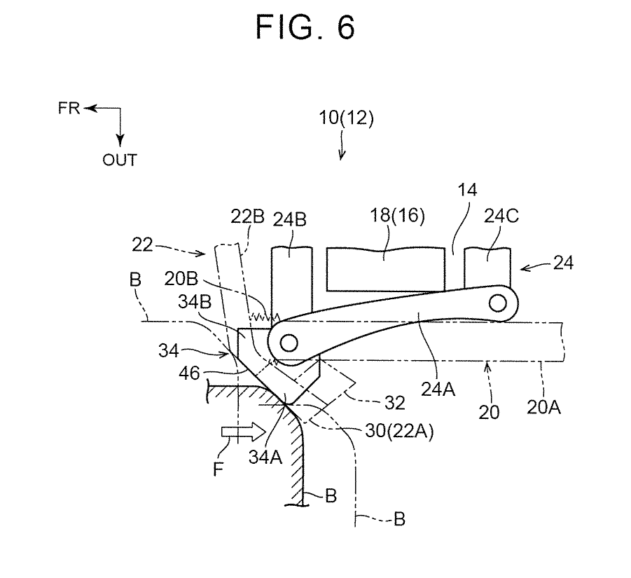

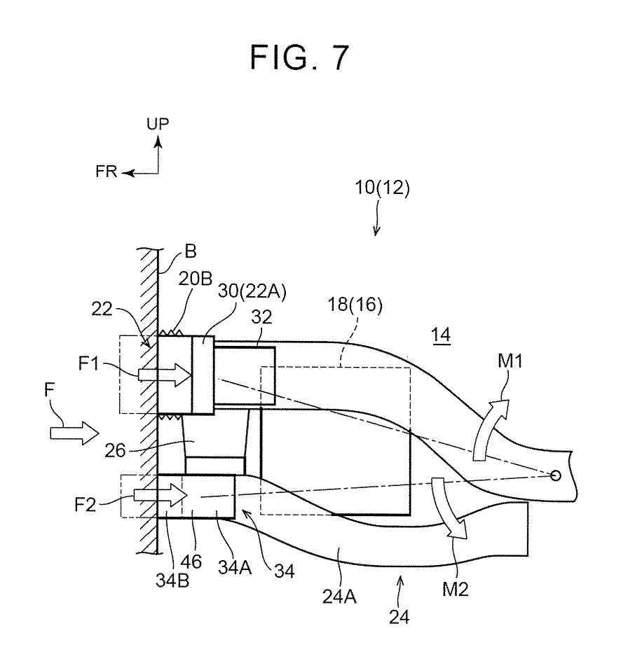

Here, in the present embodiment, when a collision object (here, a barrier B) such as an oncoming vehicle has a front end collision with the vehicle 12 with a small overlap amount in the vehicle width direction (at the time of a so-called short overlap collision), the energy absorption portion 20B is deformed by a collision load F in an axially compressive manner in the vehicle front-rear direction, as illustrated in FIGS. 6 and 7. Further, at this time, the extending portion 22A of the bumper reinforcement 22 is bent toward the vehicle rear side by the collision load F, so that the rearward protruding portion 32 abuts (collides) with the vehicle-width outer surface of the body portion 20A of the front side member 20. At the time when the rearward protruding portion 32 abuts with the vehicle-width outer surface of the body portion 20A of the front side member 20, the collision load F from the barrier B is input into a front face of the forward protruding portion 34B of the spacer 34.

That is, in the present embodiment, a timing at which the collision load F from the barrier B is input into the body portion 20A of the front side member 20 via the rearward protruding portion 32 is the same or almost the same as a timing at which the collision load F from the barrier B is input into the side rail portion 24A of the suspension member 24 via the spacer 34. In other words, a state at the time of a collision is analyzed by an electronic computer, and a shape, a size, and a position of each member, a deformation amount thereof due to the collision load F, and the like are determined so that the above timings are established.

Note that, depending on a collision form, the energy absorption portion 20B may be buckled without being deformed in an axially compressive manner. Further, since an offset yield strength of the energy absorption portion 20B with respect to the collision load F is set lower than that of the bumper reinforcement 22, the energy absorption portion 20B is generally deformed earlier than the extending portion 22A.

(Interactions and Effects) The following describes interactions and effects of the present embodiment.

In the vehicle front structure 10 configured as such, the spacer 34 protruding outwardly in the vehicle width direction from the front end of the side rail portion 24A of the suspension member 24 extends toward the vehicle-width outer side relative to the front side member 20. Accordingly, when the vehicle 12 has a short overlap collision with a barrier B, it is possible to disperse a collision load F from the barrier B to the suspension member 24 via the spacer 34. Besides, since the side rail portion 24A of the suspension member 24 is placed at a vehicle-width outer side of the power unit 16, it is possible to transmit (disperse) the collision load F to a power-unit-16 side via the suspension member 24. This makes it possible to disperse the collision load F to that side of the vehicle front portion which is opposite to a collision side via the power unit 16.

Besides, the rigidity of the spacer 34 with respect to a load along the vehicle horizontal direction is increased by the reinforcing plate 38 attached to the inner side of the hollow outer wall 36. This makes it possible to prevent the spacer 34 from being deformed unexpectedly due to the collision load F input into the spacer 34 from the barrier B along the vehicle horizontal direction, thereby making it possible to improve a transmission efficiency of the collision load F via the spacer 34. Further, the hollow outer wall 36 is reinforced by the reinforcing plate 38, so that it is possible to improve the rigidity of the spacer 34 and to achieve lightweighting.

Further, the vehicle-width outer surface of the front side of the spacer 34 is the inclined surface 46 inclined outwardly in the vehicle width direction as the vehicle-width outer surface extends toward the vehicle rear side. This causes the barrier B to directly or indirectly make slide contact with the inclined surface 46 of the spacer 34, thereby making it possible to successfully act a force on a front portion of the vehicle 12 to move away from the barrier B in a lateral direction (the vehicle width direction). As a result, it is possible to distance the front portion of the vehicle 12 from the barrier B in the lateral direction, thereby making it possible to effectively reduce the collision load F input into the front portion of the vehicle 12. This makes it possible to largely reduce a deformation amount of the passenger compartment.

Further, the spacer 34 includes the forward protruding portion 34B protruding toward the vehicle front side relative to the front end of the side rail portion 24A. This makes it possible to push forward a timing at which the collision load F from the barrier B is input into the suspension member 24 via the spacer 34, thereby making it possible to slow down the vehicle at an early stage by just that much. As a result, it is possible to lengthen a time for the collision load F to be input into the spacer 34, thereby making it possible to lengthen a time for the front portion of the vehicle 12 to be pushed by the barrier B in the lateral direction. This accordingly makes it possible to more effectively distance the front portion of the vehicle 12 away from the barrier B in the lateral direction.

Further, in the present embodiment, at the time of a short overlap collision, the extending portion 22A of the bumper reinforcement 22 is bent toward the vehicle rear side by the collision load F, so that the rearward protruding portion 32 abuts (collides) with the vehicle-width outer surface of the body portion 20A of the front side member 20. This makes it possible to bend the front side member 20 inwardly in the vehicle width direction so as to abut with the transmission 18. As a result, it is possible to transmit (disperse) the collision load F to the power unit 16 from the extending portion 22A of the bumper reinforcement 22 via the rearward protruding portion 32 and the front side member 20.

That is, a path to transmit the collision load F to the power unit 16 from the extending portion 22A of the bumper reinforcement 22 via the rearward protruding portion 32 and the front side member 20 is added, in addition to a path to transmit the collision load F to the power unit 16 from the spacer 34 via the side rail portion 24A of the suspension member 24. This accordingly makes it possible to disperse the collision load F still more efficiently.

Further, in the present embodiment, a timing at which a collision load F1 (see FIG. 7), which is part of the collision load F from the barrier B, is input into the body portion 20A of the front side member 20 via the rearward protruding portion 32 is the same or almost the same as a timing at which a collision load F2 (see FIG. 7), which is part of the collision load F, is input into the side rail portion 24A of the suspension member 24 via the spacer 34. This makes it possible to efficiently disperse the collision loads F1, F2 to the front side member 20 on an upper side and to the suspension member 24 on a lower side.

Besides, it is possible to cancel an upward bending moment M1 (see FIG. 7) acting on the front side member 20 due to the collision load F1, and a downward bending moment M2 (see FIG. 7) acting on the side rail portion 24A due to the collision load F2 to each other. This makes it possible to increase an energy absorption amount due to axial compression deformations of the front side member 20 and the side rail portion 24A.

Further, in the present embodiment, since the transmission 18 of the power unit 16 is connected to the side rail portion 24A, it is possible to efficiently transmit, to the power unit 16, the collision load F input into the side rail portion 24A of the suspension member 24 via the spacer 34. In other words, in the present embodiment in which the spacer 34 configured to transmit the collision load F is provided in the suspension member 24, the suspension member 24 is connected to the power unit 16, thereby making it possible to effectively improve a transmission efficiency of the collision load F to the power unit 16.

<Supplementary Description of Embodiment> In the above embodiment, the transmission 18 of the power unit 16 is connected to (supported by) the side rail portion 24A on the left side of the suspension member 24. However, the present invention is not limited to this, and the transmission 18 may be connected to the front portion 24B or the rear portion 24C on the left side, or the front side member 20 on the left side.

Further, in the above embodiment, the bumper reinforcement 22 includes the extending portion 22A and the rearward protruding portion 32. However, the present invention is not limited to this, and the rearward protruding portion 32, or the rearward protruding portion 32 and the extending portion 22A may not be provided.

Further, in the above embodiment, the spacer 34 is provided with the forward protruding portion 34B protruding toward the vehicle front side relative to the front end of the side rail portion 24A. However, the present invention is not limited to this, and the forward protruding portion 34B may not be provided.

Further, in the above embodiment, the vehicle-width outer surface of the front side of the spacer 34 is the inclined surface 46 inclined outwardly in the vehicle width direction as the vehicle-width outer surface extends toward the vehicle rear side. However, the present invention is not limited to this, and the vehicle-width outer surface of the spacer 34 may be provided along the vehicle front-rear direction. Even in this case, when a collision load from a collision object such as the barrier B is input into the front face of the spacer 34, the spacer 34 receives a lateral force component from the collision object, thereby allowing the vehicle to be displaced in a direction distanced from the collision object.

Further, in the above embodiment, the spacer 34 serving as the load transmission portion includes the outer wall 36 and the reinforcing plate 38 (a reinforcing portion). However, the present invention is not limited to this, and the configuration of the load transmission portion can be modified appropriately.

Further, in the above embodiment, the spacer 34 serving as the load transmission portion is formed separately from the suspension member 24, and fixed to the front end of the side rail portion 24A. However, the present invention is not limited to this, and the load transmission portion may be formed integrally with the suspension member.

In addition, the present invention can be performed with various modifications without departing from a gist of the present invention. Further, it is needless to say that a scope of the present invention is not limited to each of the above embodiments.

What is claimed is:

1. A vehicle front structure comprising:
a power unit provided in a vehicle front portion;
a front side member placed on a vehicle-width outer side relative to the power unit;
a suspension member placed on a vehicle lower side below the front side member, the suspension member including a side rail portion placed on the vehicle-width outer side relative to the power unit; and
a load transmission portion protruding from a front end of the side rail portion toward the vehicle-width outer side, the load transmission portion being extended toward the vehicle-width outer side relative to the front side member.

2. The vehicle front structure according to claim 1, wherein:
the load transmission portion is provided with a reinforcing portion, the reinforcing portion increasing a rigidity with respect to a load along a vehicle horizontal direction.

3. The vehicle front structure according to claim 2, wherein:
the load transmission portion includes an outer wall formed in a hollow shape; and
the reinforcing portion is a reinforcing plate attached to an inner side of the outer wall.

4. The vehicle front structure according to claim 1, wherein:
at least a vehicle-width outer surface of a front side of the load transmission portion is inclined or curved outwardly in a vehicle width direction as the vehicle-width outer surface extends toward a vehicle rear side.

5. The vehicle front structure according to claim 1, wherein:
the load transmission portion protrudes toward a vehicle front side relative to a front the side rail portion.

6. The vehicle front structure according to claim 1, further comprising:
a bumper reinforcement fixed to a front end of the front side member, the bumper reinforcement including an extending portion extended toward the vehicle-width outer side relative to the front side member; and
a rearward protruding portion protruding from the extending portion toward a vehicle rear side.

7. The vehicle front structure according to claim 1, wherein:
the power unit is connected to the side rail portion.
